(19) United States
(12) Patent Application Publication
(10) Pub. No.: US 2015/0350217 A1
(43) Pub. Date: Dec. 3, 2015

(54) METHOD AND SYSTEM FOR ALLOWING ACCESS TO ELECTRONIC DEVICES

(71) Applicant: Sony Corporation, Tokyo (JP)

(72) Inventor: Brad Thorson, Fallbrook, CA (US)

(73) Assignee: Sony Corporation, Tokyo (JP)

(21) Appl. No.: 14/293,082

(22) Filed: Jun. 2, 2014

(51) Int. Cl. H04L 29/06; H04L 29/08

(52) U.S. Cl. CPC H04L 63/102; H04L 67/22

(57) ABSTRACT

Various aspects of a method and a system for allowing access to electronic devices are disclosed herein. The method, in an online application server communicably coupled to a first electronic device and a second electronic device, comprises receiving a progress status from the first electronic device. The received progress status corresponds to a user activity performed by a user of the first electronic device. Based on the received progress status, an access to the second electronic device is allowed.

### FIELD

Various embodiments of the disclosure relate to allowing access to electronic devices. More specifically, various embodiments of the disclosure relate to allowing access to electronic devices, based on one or more activities performed by a user.

### BACKGROUND

Recent advancements in the field of information security have made it possible to provide selective permissions to a user, to access electronic devices (such as a television or a smartphone). A supervisor (such as a caretaker of the user) associated with the user, may provide the selective permissions to the user to access one or more features and/or one or more applications of the electronic devices. Such permissions may be selected by the supervisor, based on a manual selection of access rights associated with the electronic devices.

In certain scenarios, the supervisor may restrict the user's access to the one or more features and/or one or more applications of the electronic devices, until the user achieves a preset goal associated with each of the one or more activities performed by the user. In such scenarios, the supervisor may be required to continuously manually monitor the progress status of the one or more activities performed by the user. However, active intervention of the supervisor by manual monitoring with regard to access to the electronic devices may not be desirable by the user.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

A method and a system are provided for allowing access to electronic devices substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram illustrating a network environment for allowing access to electronic devices, in accordance with an embodiment of the disclosure.

FIG. 2 is a block diagram illustrating an exemplary tracking device, in accordance with an embodiment of the disclosure.

FIG. 3 is a block diagram illustrating an exemplary online application server, in accordance with an embodiment of the disclosure.

FIG. 4 is a flow chart illustrating an exemplary method for allowing access to electronic devices, in accordance with an embodiment of the disclosure.

FIG. 5 is a flow chart illustrating another exemplary method for allowing access to electronic devices, in accordance with an embodiment of the disclosure.

### DETAILED DESCRIPTION

Exemplary aspects of the disclosure may comprise a method for allowing access to electronic devices. The method may include receiving a progress status from a first electronic device. The received progress status may correspond to a user activity performed by a user of the first electronic device. The method may include allowing access to a second electronic device based on the received progress status.

In an embodiment, the method may include comparing the received progress status with a set of threshold values associated with the user activity. In an embodiment, the user activity may include one or more of performing exercises, playing outdoor games, performing work assignments, scoring grades in exams, reading books, performing chores, and/or participating in daily routine activities. In an embodiment, the first electronic device may include one or more of a smartphone, a touch screen device, a laptop, a tablet computer, a smartwatch, an imaging device, a personal digital assistant device, and/or fitness equipment. In an embodiment, the second electronic device may include one or more of a laptop, a television, a tablet computer, a desktop computer, a mobile phone, a video game console, a digital camera, and/or an audio/video player.

In an embodiment, the method may include determining a number of points based on the received progress status. In an embodiment, the determined number of points may be stored in a database corresponding to a user profile associated with the user. In an embodiment, the method may include determining a time period for allowing the access to the second electronic device based on the determined number of points.

In an embodiment, the method may include determining one or more applications and/or features associated with the second electronic device based on the determined number of points that cross a threshold value. In an embodiment, the one or more applications and/or features associated with the second electronic device may include one or more of games, multimedia, broadcast channels, social networking sites, messaging, calling and/or multimedia content associated with the second electronic device. In an embodiment, the allowing of the access to the second electronic device may include one or more of unlocking the second electronic device, unlocking one or more features associated with the second electronic device, and/or applications associated with the second electronic device.

Exemplary aspects of the disclosure may comprise a method for allowing access to electronic devices. The method may include monitoring progress of a user activity performed by a user of the first electronic device. The method may include determining a progress status of the user activity based on the monitoring. The method may include allowing access to a second electronic device based on the determined progress status.

In an embodiment, the method may include monitoring progress of the user activity. In an embodiment, the progress status may be determined based on the monitoring. In an embodiment, the method may include determining a number of points based on the determined progress status. In an embodiment, the determined number of points may be stored in the database corresponding to a user profile associated with the user. In an embodiment, the method may include determining a time period for allowing the access to the second electronic device based on the determined number of points. In an embodiment, the method may include determining one or more applications and/or features associated with the second electronic device for which the access is allowed based on the determined number of points.

Exemplary aspects of the disclosure may comprise a method for allowing a set of access rights associated with an electronic device. The method may include receiving a progress status from one of one or more electronic devices. The received progress status may correspond to each of one or more user activities performed by a user of the one or more electronic devices. The method may include allowing the set of access rights associated with the one or more electronic devices based on the received progress status. In an embodiment, the method may include comparing the received progress status with the set of threshold values associated with each of the one or more user activities.

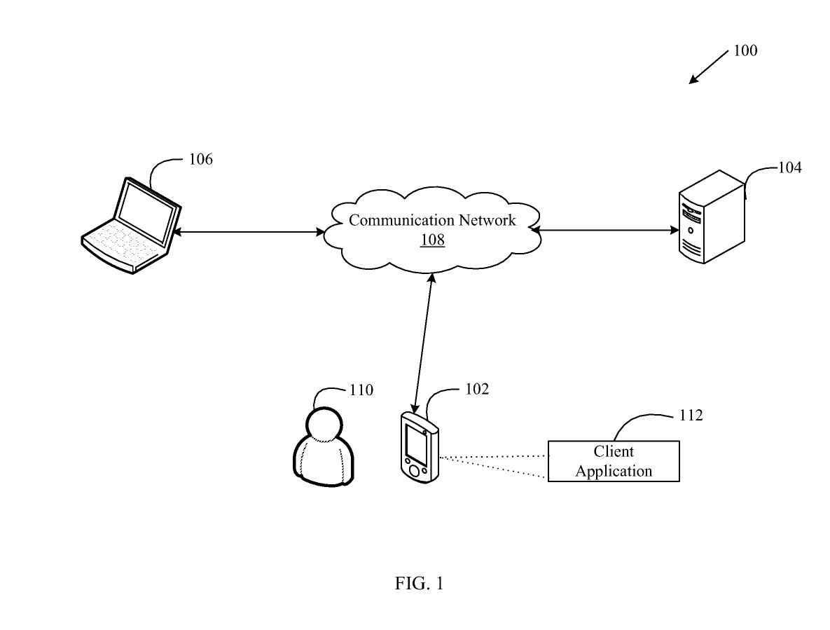

FIG. 1 is a block diagram of a network environment, in accordance with an embodiment of the disclosure. With reference to FIG. 1, there is shown a network environment 100. The network environment 100 may comprise a tracking device 102, an online application server 104, a user device 106, a communication network 108, and a user 110. The user device 106 may be communicatively coupled with the tracking device 102, and the online application server 104, via the communication network 108. The tracking device 102 and the user device 106, may be associated with the user 110. The tracking device 102 may comprise a client application 112.

Although for simplicity, FIG. 1 shows only one tracking device (such as the tracking device 102), only one user device (such as the user device 106), and only one user (such as the user 110), one skilled in the art may appreciate that the implementation of disclosed embodiments may occur for a number of tracking devices, user devices and users, without limiting the scope of the disclosure.

The tracking device 102 may comprise suitable logic, circuitry, interfaces, and/or code that may be operable to monitor one or more user activities, performed by the user 110. To monitor the one or more user activities, the tracking device 102 may include one or more sensors, such as a Global Positioning system (GPS) sensor, an accelerometer sensor, a pedometer sensor, and/or a gyroscope sensor. The tracking device 102 may include a display screen to provide a user interface (UI) to render progress status of the one or more user activities performed by the user 110. Examples of the tracking device 102 may include, but are not limited to, an electronic device and/or fitness equipment. The electronic device may be one of a smartphone, a touch screen device, a laptop, a tablet computer, a smartwatch, an imaging device (such as a camera), a personal digital assistant (PDA) device, and/or the like. The fitness equipment may include a treadmill, a cross-trainer, and/or an exercise bike.

The online application server 104 may comprise suitable logic, circuitry, interfaces, and/or code that may be operable to determine a set of access rights allowed to the user 110, to access the user device 106. The online application server 104 may be further operable to host web-based applications for the tracking device 102, and/or the user device 106. Examples of the web-based applications may include, but are not limited to webmail, online retail sales, online auctions, wikis, audio-visual conferences, multi-player games, live video sessions, and/or live chat sessions. Such web-based applications may rely on a common web browser to execute the online application hosted by the online application server 104. The online application server 104 may be implemented as a cluster of a plurality of computing devices, configured to perform as the online application server 104. The online application server 104 may optionally include a storage medium to store multimedia content, such as an audio file and/or a video file.

The user device 106 may correspond to an electronic device and comprise suitable logic, circuitry, interfaces, and/or code that may be operable to communicate with the tracking device 102, and the online application server 104. The user device 106 may comprise one or more features and/or one or more applications that may be associated with a set of access rights. The user 110 may be allowed to access the one or more features and/or one or more applications of the user device 106, based on one or more of the set of access rights allowed to the user 110. Examples of the user device 106 may include, but are not limited to laptops, televisions (TV), tablet computers, desktop computers, mobile phones, video game consoles, digital cameras, audio/video players, and other such devices.

The communication network 108 may include a medium through which the tracking device 102, and/or the user device 106, may communicate with the online application server 104. Examples of the communication network 108 may include, but are not limited to the Internet, a Wireless Fidelity (WiFi) network, a Wireless Local Area Network (WLAN), a Local Area Network (LAN), a telephone line (POTS), and/or a Metropolitan Area Network (MAN). Various devices in the network environment 100 may be operable to connect to the communication network 108, in accordance with various wired and wireless communication protocols, such as Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols.

The client application 112 may comprise suitable logic, interface, and/or code that may be operable to associate the tracking device 102 with the online application server 104, and/or the user device 106. In an embodiment, the client application 112 may provide a UI on a display screen of the tracking device 102, to enable one or more user devices, such as the user device 106, to communicate with the tracking device 102. The client application 112 may enable the tracking device 102, to allow the set of access rights associated with the user device 106, to the user 110. Such a set of access rights is allowed to the user 110, based on a progress status of a user activity performed by the user 110. In an embodiment, the client application 112 may further enable the tracking device 102 to communicate with the online application server 104. In such an embodiment, the tracking device 102 may transmit progress status of the one or more user activities to the online application server 104, via the client application 112.

In an embodiment, the client application 112 may enable the tracking device 102 to communicate with one or more electronic devices, such as an electronic device associated with another user (hereinafter referred to as a supervisor of the user 110). In such an embodiment, the tracking device 102 may receive the progress status of the one or more user activities from the one or more electronic devices that include the user device 106. In an embodiment, the one or more electronic devices may transmit the progress status of the one or more user activities to the online application server 104.

In an embodiment, the client application 112 may be installed in the user device 106. In such an embodiment, the client application 112 may provide a UI on a display screen of the user device 106. The user 110 and/or the supervisor of the user 110 may configure one or more operations associated with the tracking device 102, the online application server 104, and/or the user device 106, via the UI rendered on the display screen of the user device 106.

In operation, the tracking device 102 may be operable to monitor a user activity performed by the user 110. Examples of the user activity may include, but are not limited to, performing an exercise, playing an outdoor game, completing work assignments, scoring grades in exams, reading books, and/or participating in daily routine activities (such as taking a bath, eating food, going to school, cooking).

In an embodiment, the tracking device 102 may automatically determine a progress status of the user activity, based on a degree of completion of the user activity. In an embodiment, the tracking device 102 may compare the progress status with a set of threshold values associated with the user activity. The tracking device 102 may retrieve the set of threshold values from the local memory. In such an embodiment, based on the comparison, the tracking device 102 may allow the set of access rights associated with the user device 106, to the user 110. In an embodiment, when the progress status exceeds the set of threshold values, the tracking device may determine a number of points based on the progress status beyond the set of threshold values, in addition to the set of access rights associated with the user device 106, allowed to the user 110. In an embodiment, the determined number of points may be exchanged for another set of access rights associated with the user device 106, or another user device.

In an embodiment, the progress status of the user activity may be manually provided by the user 110 and/or the supervisor of the user 110. In such an embodiment, the user 110 may provide the progress status of the user activity, via the UI rendered on the display screen of the tracking device 102. In an embodiment, the tracking device 102 may transmit the determined progress status to the online application server 104. In such an embodiment, the online application server 104 may compare the progress status received from the tracking device 102 with the set of threshold values associated with the user activity. The online application server 104 may retrieve the set of threshold values from a local memory. The online application server 104 may allow the set of access rights associated with the user device 106, to the user 110, based on the comparison. The set of access rights associated with the user device 106 may include one or more of a right to unlock the user device 106, a right to unlock one or more applications, and/or a right to unlock one or more features associated with user device 106. The one or more applications may include games, multimedia, access to social networking sites, access to broadcast channels, and/or the like. The one or more features may include settings associated with the user device 106, voice and/or video calling, text messaging, and/or the like.

In an embodiment, the tracking device 102 may determine a number of points based on the progress status. In such an embodiment, the tracking device 102 may allow the set of access rights associated with the user device 106, to the user 110, based on the determined number of points. In an embodiment, the tracking device 102 may transmit the progress status to the online application server 104. In such an embodiment, the online application server 104 may determine a number of points based on the progress status received from the tracking device 102. In such an embodiment, the online application server 104 may allow the set of access rights associated with the user device 106, to the user 110, based on the determined number of points.

In an embodiment, the tracking device 102 may determine a number of points based on a current progress status of the user activity. In such an embodiment, as the user activity progresses towards completion, the tracking device 102 may determine the number of points that correspond to the current progress status of the user activity. In an embodiment, the tracking device 102 may determine the number of points associated with the user activity after successful completion of the user activity. In an embodiment, the tracking device 102 may allow the set of access rights associated with the user device 106, to the user 110, based on the determined number of points. In an embodiment, the tracking device 102 may transmit the number of points to the online application server 104.

In an embodiment, the progress status of the user activity may be automatically determined by the one or more sensors in the tracking device 102, such as a number of steps taken by the user 110, detected by the pedometer in the tracking device 102. In an embodiment, the tracking device 102 may be worn by the user 110. In an embodiment, the tracking device 102 may be carried on the person of the user 110. In an embodiment, the supervisor of the user 110 may manually provide the progress status of the user activity to the tracking device 102, via another tracking device (not shown).

In an exemplary scenario, the tracking device 102 may monitor a fitness-related user activity, such as a number of steps taken by the user 110 on a treadmill. In such an exemplary scenario, the tracking device 102 may be a mobile electronic device, such as a smartwatch, that may be worn by the user 110. The smartwatch may include one or more sensors, such as an accelerometer, a gyroscope, and/or a GPS. A fitness-related application, such as a pedometer application, may be installed in the smartwatch. The pedometer application of the smartwatch may determine the number of steps taken by the user 110. The smartwatch may further determine distance travelled by the user 110.

The smartwatch may compare the number of steps with a predetermined number of steps stored in the local memory. In instances where the number of steps equals the predetermined number of steps, the smartwatch may allow a set of access rights associated with the user device 106 (such as a television). For example, the user 110 may be allowed to watch television and/or unlock a broadcast channel when the number of steps taken by the user 110 is, “250 steps”. In instances where the number of steps, such as “200 steps”, is less than the predetermined number of steps, such as “250 steps”, the user 110 may not be allowed to access the television. In instances where the number of steps, such as “300 steps”, exceeds the predetermined number of steps, such as “250 steps”, the user 110 may be allowed to access the television. The user 110 may further earn a number of points, such as “2.5 points”, based on the additional number of steps, such as “50 steps”, taken by the user 110. The number of points earned by the user 110 may be stored in the database that corresponds to a user profile associated with the user 110. The database may be stored in the local memory. The tracking device 102 may allow another set of access rights associated with the user device 106, or another user device, in exchange for the number of points earned by the user 110.

In another exemplary scenario, the smartwatch may determine a number of points, based on the number of steps taken by the user 110. Based on the number of points, the tracking device 102 may allow the set of access rights associated with the television to the user 110. In an embodiment, the smartwatch may transmit the number of steps taken by the user 110 to the online application server 104. In such an embodiment, the online application server 104 may compare the number of steps with a predetermined number of steps, stored in the local memory. Based on the comparison, the online application server 104 may allow a set of access rights associated with the television to the user 110. In an embodiment, the smartwatch may transmit the number of points to the online application server 104. Based on the number of points, the online application server 104 may allow the set of access rights, associated with the television to the user 110.

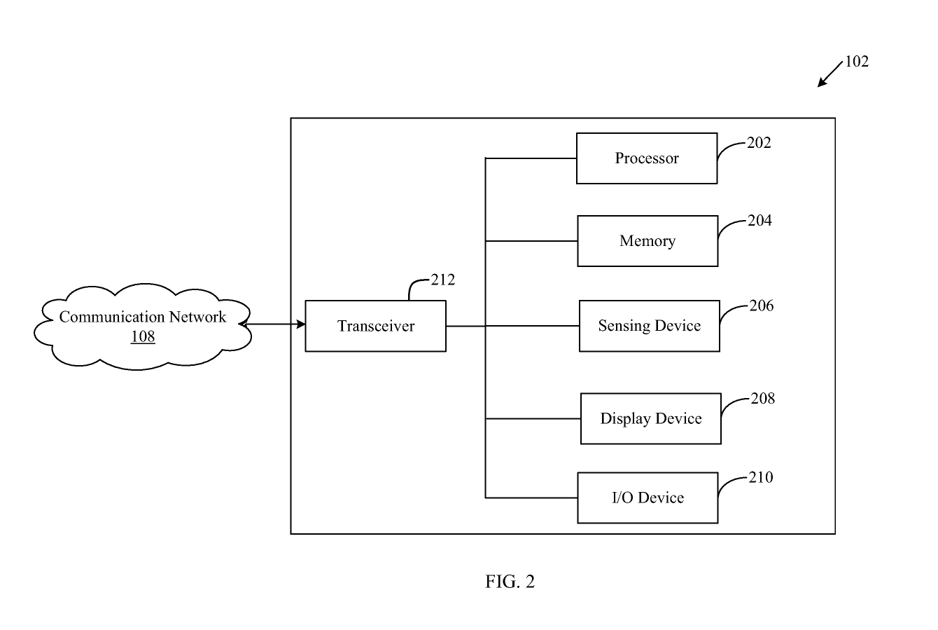

FIG. 2 is a block diagram illustrating a tracking device, in accordance with an embodiment of the disclosure. FIG. 2 is explained in conjunction with elements from FIG. 1. With reference to FIG. 2, there is shown the tracking device 102. The tracking device 102 may comprise one or more processors, such as a processor 202, a memory 204, one or more sensing devices, such as a sensing device 206, a display screen 208, one or more Input-Output (I/O) devices, such as an I/O device 210, and a transceiver 212. The processor 202 may be communicatively coupled to the memory 204, and the sensing device 206. The processor 202 may be further communicatively coupled to the display screen 208, the I/O device 210, and the transceiver 212.

The processor 202 may comprise suitable logic, circuitry, interfaces, and/or code that may be operable to execute a set of instructions stored in the memory 204. The processor 202 may be implemented, based on a number of processor technologies known in the art. Examples of the processor 202 may include an X86-based processor, a Reduced Instruction Set Computing (RISC) processor, an Application-Specific Integrated Circuit (ASIC) processor, a Complex Instruction Set Computing (CISC) processor, and/or any other processor.

The memory 204 may comprise suitable logic, circuitry, and/or interfaces that may be operable to store a machine code and/or a computer program with at least one code section executable by the processor 202. The memory 204 may be further operable to store a database that corresponds to one or more user profiles associated with each of the one or more users, such as the user 110. In an embodiment, the memory 204 may be operable to store a progress log that corresponds to the progress status of each of the one or more activities performed by the user 110. The progress log may include one or more data values that correspond to the progress status of each of the one or more activities performed by the user 110, over a period of time. The memory 204 may be further operable to store a first conversion algorithm. The first conversion algorithm may convert the one or more data values retrieved from the progress log, such as a number of steps taken by the user 110, into a number of points. The memory 204 may be further operable to store a second conversion algorithm. The second conversion algorithm may convert the number of points into another set of access rights associated with the user device 106, or another user device. The memory 204 may be further operable to store a progress log that is determined by the processor 202, based on the progress status of the user activity. The memory 204 may be further operable to store a set of threshold values associated with each of the one or more user activities performed by the user 110. The memory 204 may store at least one code section associated with the sensing device 206. The memory 204 may further store at least one code section associated with one or more applications installed on the tracking device 102. Examples of such one or more applications may include, but are not limited to the client application 112, a social networking application, a web browser application, games-based applications, music-based applications, an e-mail application and/or a text-chat application. Examples of implementation of the memory 204 may include, but are not limited to Random Access Memory (RAM), Read Only Memory (ROM), Hard Disk Drive (HDD), and/or a Secure Digital (SD) card.

The sensing device 206 may comprise suitable logic, circuitry, interfaces, and/or code that may be operable to detect progress status of one or more user activities performed by the user 110. In an embodiment, the sensing device 206 may include one or more sensors, such as a Global Positioning system (GPS) sensor, an accelerometer sensor, a pedometer sensor, and/or a gyroscope sensor. In an embodiment, the sensing device 206 may include an imaging sensor (such as a camera).

The display screen 208 may comprise suitable logic, circuitry, interfaces, and/or code that may be operable to display a graphical user interface (GUI) associated with the tracking device 102. The display screen 208 may be realized through several known technologies such as, but not limited to Liquid Crystal Display (LCD) based display, Light Emitting Diode (LED) based display, and/or Organic LED (OLED) display technology. Further, the display screen 208 may be a touch screen that may receive input from a user.

The I/O device 210 may comprise various input and output devices that may be operable to receive an input or provide an output to the user 110 and/or the supervisor of the user 110. The I/O device 210 may comprise various input and output devices that may be operable to communicate with the processor 202. Examples of the input devices may include, but are not limited to a keyboard, a mouse, a joystick, a touch screen, a microphone, a camera, a motion sensor, a light sensor, and/or a docking station. Examples of the output devices may include, but are not limited to, the display screen 208, and/or a speaker.

The transceiver 212 may comprise suitable logic, circuitry, interfaces, and/or code that may be operable to communicate with the online application server 104, and/or the user device 106, via various communication interfaces. The transceiver 212 may implement known technologies for supporting wired or wireless communication with the communication network 108. The transceiver 212 may include, but is not limited to an antenna, a radio frequency (RF) transceiver, one or more amplifiers, a tuner, one or more oscillators, a digital signal processor, a coder-decoder (CODEC) chipset, a subscriber identity module (SIM) card, and/or a memory. The transceiver 212 may communicate, via wireless communication, with networks, such as: the Internet, an Intranet and/or a wireless network, such as a cellular telephone network, a wireless local area network (LAN) and/or a metropolitan area network (MAN). The wireless communication may use any of a plurality of communication standards, protocols and technologies including, but not limited to Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

In operation, the sensing device 206 may be operable to detect the user activity performed by the user 110. In an embodiment, the user 110 may provide a user input to initiate the client application 112, via the I/O device 210. In response to the user input, the processor 202 may initiate the client application 112, to monitor the user activity performed by the user 110. For example, the user 110 may initiate a pedometer application installed in the tracking device 102 (such as a cellular phone or a smartwatch) to monitor the user activity, such as number of steps taken by the user 110.

The processor 202 may be operable to determine progress status of the user activity performed by the user 110, based on a degree of completion of the user activity. The processor 202 may determine the degree of completion achieved by the user 110, based on one or more goals related to the user activity. The processor 202, in conjunction with the sensing device 206, may continuously monitor the user activity. In an exemplary scenario, the processor 202, in conjunction with the pedometer, may determine the progress status of the user activity performed by the user 110. In such an exemplary scenario the progress status may include one or more data values, such as number of steps taken by the user 110 (such as, “1000 steps”), calories burnt in taking the number of steps (such as, “100 calories”), and/or time taken by the user 110 in taking the number of steps (such as, “30 minutes”). In an embodiment, the processor 202 may record the one or more data values that correspond to the progress status of the user activity in the progress log over a period of time. The progress log may be stored in the memory 204.

In an embodiment, the processor 202 may retrieve the one or more data values associated with the progress status of the user activity performed by the user 110, from the progress log. In an embodiment, the processor 202 may be operable to determine a mode for allowing access to the user device 106. In an embodiment, the mode may be provided by the user 110, via the UI rendered on the display screen of the tracking device 102. In an embodiment, when the determined mode is a first mode, the processor 202 may be operable to compare the retrieved one or more data values associated with the progress status of the user activity with the set of threshold values. In an embodiment, a subset set of access rights may correspond to each threshold value of the set of threshold values.

In an exemplary scenario, the processor 202 may retrieve one or more data values, such as “550 steps”, from the memory 204. The processor 202 may compare the retrieved one or more data values with one or more of the set of threshold values associated with the user activity. The set of threshold values associated with the user activity may include a set of three data values, such as “250 steps”, “500 steps”, and “750 steps”. The set of threshold values may be retrieved from the memory 204. In such an exemplary scenario, as the progress status of the user activity exceeds the second threshold value (“500 steps”), the processor 202 may allow a first subset from the set of access rights that corresponds to the second threshold value (“500 steps”), to the user 110. For example, the user 110 may be allowed to access the user device 106 to watch a movie and/or play a game.

In an embodiment, the one or more data values associated with the progress status of the user activity may exceed the highest threshold value of the set of threshold values. In such an embodiment, the processor 202 may determine a number of points corresponding to the amount by which the one or more data values exceed the highest threshold value of the set of threshold values. In an exemplary scenario, the processor 202 may retrieve one or more data values, such as “1000 steps”, from the memory 204. The set of threshold values associated with the user activity may include a set of three values, such as “250 steps”, “500 steps”, and “750 steps”. In such an exemplary scenario, as the progress status of the user activity exceeds the highest threshold value (“750 steps”), the processor 202 may be operable to determine a number of points, based on the additional number of steps, such as “250 steps”, taken by the user 110. The processor 202 may be operable to store the determined number of points in a database that corresponds to a user profile associated with the user 110. The database may be stored in the memory 204. In an embodiment, the number of steps may be converted into the number of points based on the first conversion algorithm stored in the memory 204.

In an embodiment, the processor 202 may determine that the progress status of the user activity is less than each threshold value of the set of threshold values. In such an embodiment, the processor 202 may not allow the set of access rights associated with the user device 106 to the user 110.

In an embodiment, the processor 202 may be operable to determine the progress status of one or more user activities performed by the user 110. The processor 202 may compare the determined progress status of each of the one or more user activities with the set of threshold values that corresponds to the respective one or more user activities, retrieved from the memory 204. In instances where the progress status of each of the one or more user activities exceeds or equals the corresponding set of threshold values, the processor 202 may allow the set of access rights associated with user device 106, to the user 110. In an embodiment, the processor 202 may transmit the determined progress status of each of the one or more user activities to the online application server 104. In an embodiment, more than one tracking device, which includes the tracking device 102, may be used to determine the progress status of the one or more user activities performed by the user 110. In such an embodiment, such tracking devices, which include the tracking device 102, may transmit the determined progress status of the one or more user activities to the online application server 104.

In an embodiment, the processor 202 may automatically configure the set of threshold values, based on a first set of criteria. The first set of criteria may include a health status of the user 110, age of the user 110, preferences of the user 110, and/or the like. In an embodiment, the user 110, and/or the supervisor of the user 110, may manually configure the set of threshold values, via the UI, based on the second set of criteria. The second set of criteria may include a portion of homework assignment completed by the user 110, grades scored by the user, and/or the like. In such an embodiment, the processor 202 may render a UI of the client application 112 on the display screen 208. In an embodiment, the user 110 and/or the supervisor of the user 110 may manually configure the set of threshold values that corresponds to one or more user activities to be performed by the user 110.

In an embodiment, the user 110, and/or the supervisor of the user 110, may configure the first conversion algorithm stored in the memory 204, via the UI. The first conversion algorithm may be operable to convert the one or more data values of the progress status of the user activity into the number of points. In an embodiment, when the determined mode is a second mode, the processor 202 may determine a number of points that correspond to the progress status of the user activity. In an embodiment, the determined progress status of the user activity may be converted to the number of points, based on the first conversion algorithm retrieved from the memory 204. For example, for each step taken by the user 110, the user 110 may earn, “0.5 points”. In an embodiment, the processor 202 may store the number of points earned by the user 110 in the database that corresponds to the user profile associated with the user 110. In an embodiment, the user 110, and/or the supervisor of the user 110, may configure the first conversion algorithm that corresponds to one or more user activities to be performed by the user 110.

In an embodiment, the user 110, and/or the supervisor of the user 110, may configure the second conversion algorithm. The second conversion algorithm may be operable to convert the number of points into another set of access rights associated with the user device 106, or another user device. In such an embodiment, the processor 202 may execute the second conversion algorithm, retrieved from the memory 204, to convert the number of points earned by the user 110 into another set of access rights associated with the user device 106, or another user device. Each access right of the other set of access rights may be allowed when the number of points earned by the user 110 are equal to or exceeds a predetermined number of points. In an embodiment, the predetermined number of points may be provided by the user 110. For example, to unlock the television may require “10 points”. In another example, to unlock a specific broadcast channel may require, “an additional 10 points”. In an embodiment, when the number of points earned by the user 110 crosses a threshold level, the processor 202 may determine one or more applications and/or features associated with the user device 106. For example, when the number of points earned by the user crosses “50 points”, the processor 202 may determine a multimedia content, such as a movie, recorded in the user device 106. The processor 202 may allow the user 110 to view the multimedia content on the user device 106. The processor 202 may debit the number of points from the database that corresponds to the user profile associated with the user 110, based on one or more of another set of access rights allowed by the processor 202. In instances where the user 110 does not have sufficient number of points, the processor 202 may not allow one or more of the sets of access rights associated with the user device 106, to the user 110. In such an embodiment, the processor 202 may determine a time period for which another set of access rights associated with the user device 106, may be allowed to the user 110. The processor 202 may determine the time period, based on the number of points, left-over in the database that corresponds to the user profile associated with the user 110. For example, the processor 202 may determine an hour of watching television in exchange for, “10 points” The processor 202 may debit the number of points from the database that corresponds to the user profile associated with the user 110, based on time period for which another set of access rights are allowed. In an embodiment, the processor 202 may transmit the determined number of points to the online application server 104. In an embodiment, the user 110, and/or the supervisor of the user 110, may configure the second conversion algorithm that corresponds to one or more user activities to be performed by the user 110.

In an embodiment, the processor 202 may receive information regarding the progress status of the user activity, via the I/O device 210. In such an embodiment, the user 110 may manually input the progress status of the user activity, via the I/O device 210. In an embodiment, the processor 202 may transmit a notification to an electronic device, communicably coupled to the tracking device 102. The electronic device may be associated with the supervisor of the user 110. The notification may inform the supervisor about the progress status provided by the user 110. The supervisor may verify the progress status entered by the user 110, via a UI on the display screen 208 of the electronic device. The processor 202 may determine that the progress status of the user activity entered by the user 110 is correct, based on a verification received from the electronic device.

In an embodiment, the supervisor may manually input the progress status of the user activity into the tracking device 102, via the electronic device. In an embodiment, the supervisor may manually input the progress status of the user activity, via the tracking device 102. In an embodiment, the user 110, and/or the supervisor of the user 110, may configure the tracking device 102 to add and/or delete one or more access rights from the set of access rights associated with the user device 106. In such an embodiment, the processor 202 may render a UI of the client application 112, on the display screen 208 of the tracking device 102, to configure the tracking device 102.

In an embodiment, the user 110, and/or the supervisor of the user 110, may configure the tracking device 102 to associate one or more user devices with the tracking device 102. In such an embodiment, the processor 202 may render a UI of the client application 112, on the display screen 208 of the tracking device 102, to configure the tracking device 102. In an embodiment, the user 110, and/or the supervisor of the user 110, may configure the tracking device 102 to add and/or delete one or more access rights from the set of access rights associated with each of the one or more user devices. In an embodiment, the user 110, and/or the supervisor of the user 110, may configure the tracking device 102 to disconnect from the one or more user devices that may include the user device 106.

In an embodiment, the user 110, and/or the supervisor of the user 110, may configure the tracking device 102 to add, delete and/or modify one or more user activities to be performed by the user 110. In such an embodiment, the processor 202 may render a UI of the client application 112, on the display screen 208, to configure the tracking device 102.

In an embodiment, the functionalities of the tracking device 102 may be implemented in the user device 106. In such an embodiment, the processor 202 may determine progress status of the user activity performed by the user 110. The processor 202 may allow the set of access rights associated with the tracking device 102, and/or the user device 106, to the user 110, based on the determined progress status.

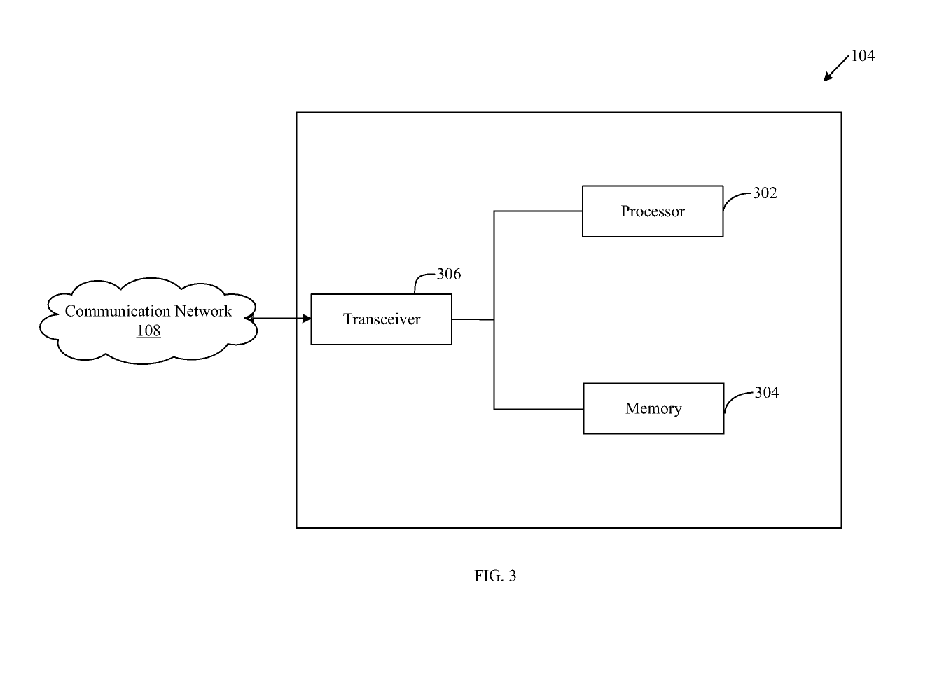

FIG. 3 is a block diagram illustrating an online application server, in accordance with an embodiment of the disclosure. FIG. 3 is explained in conjunction with elements from FIG. 1 and FIG. 2. With reference to FIG. 3, there is shown the online application server 104. The online application server 104 may comprise one or more processors, such as a processor 302, a memory 304, and a transceiver 306. The processor 302 may be communicatively coupled to the memory 304 and the transceiver 306.

The processor 302 may comprise suitable logic, circuitry, interfaces, and/or code that may be operable to execute a set of instructions stored in the memory 304. The processor 302 may be implemented, based on a number of processor technologies known in the art. Examples of the processor 302 may be: an X86-based processor, a Reduced Instruction Set Computing (RISC) processor, an Application-Specific Integrated Circuit (ASIC) processor, a Complex Instruction Set Computing (CISC) processor, and/or other processors.

The memory 304 may comprise suitable logic, circuitry, and/or interfaces that may be operable to store a machine code and/or a computer program having at least one code section executable by the processor 302. The memory 304 may be further operable to store a database that correspond to one or more user profiles associated with each of the one or more users, such as the user 110. In an embodiment, the memory 304 may be operable to store a progress log that corresponds to the progress status of each of the one or more activities performed by the user 110. The memory 304 may be further operable to store a first conversion algorithm that converts the one or more data values retrieved from the progress log, such as a number of steps taken by the user 110, into a number of points. The memory 304 may be further operable to store a second conversion algorithm that converts the number of points into another set of access rights associated with the user device 106, or another user device. The memory 304 may be further operable to store a set of threshold values associated with each of the one or more user activities performed by the user 110. In an embodiment, the memory 304 may further store a server side application associated with the client application 112. Examples of implementation of the memory 304 may include, but are not limited to: Random Access Memory (RAM), Read Only Memory (ROM), Hard Disk Drive (HDD), and/or a Secure Digital (SD) card.

The transceiver 306 may comprise suitable logic, circuitry, interfaces, and/or code that may be operable to communicate with the tracking device 102, and/or the user device 106, via various communication interfaces. The functionality of the transceiver 306 may be similar to the functionality of the transceiver 212, as explained in FIG. 2.

In an embodiment, the processor 302 may be operable to receive the progress status of the user activity performed by the user 110, from the tracking device 102. In an embodiment, the processor 302 may record the one or more data values that correspond to the progress status of the user activity, in a progress log that may be stored in the memory 304. In an embodiment, the processor 302 may be operable to determine a mode for allowing access to the user device 106. In an embodiment, the mode may be provided by the user 110, via the UI rendered on the display screen of the tracking device 102.

In an embodiment, when the determined mode is a first mode, the processor 302 may be operable to compare the progress status received from the tracking device 102, with the set of threshold values associated with the user activity. The set of threshold values may be retrieved from the memory 304. Based on the comparison, the processor 302 may allow the set of access rights associated with the user device 106, to the user 110.

In an embodiment, when the determined mode is a second mode, the processor 302 may determine a number of points that correspond to the progress status of the user activity, based on the first conversion algorithm. In an embodiment, the processor 302 may receive a number of points that correspond to the progress status of the user activity, from the tracking device 102. In an embodiment, the processor 302 may store the number of points in the database that corresponds to the user profile associated with the user 110. In an embodiment, processor 302 may store the user profile associated with the user 110, in the memory 304. In an embodiment, based on the second conversion algorithm, the processor 302 may determine another set of access rights associated with the user device 106 or another user device, to the user 110.

In an embodiment, the user 110 may log in to the user profile of the user 110, to provide the progress status of the user activity performed by the user 110. In an embodiment, the supervisor of the user 110 may log into the user profile of the user 110 to verify the progress status of the user activity performed by the user 110. In an embodiment, the processor 302 may be operable to host a web page that corresponds to a user profile of the user 110. In an embodiment, the user 110 and/or the supervisor of the user 110, may log into the user profile of the user 110, via the web page. In an embodiment, the user 110, and/or the supervisor of the user 110, may log into the user profile of the user 110, via the client application 112. In an embodiment, the user 110, or the supervisor of the user 110, may log into the user profile of the user 110, via an electronic device. The electronic device may be the tracking device 102, the user device 106, or another electronic device, communicably connected with the online application server 104.

In an embodiment, the user 110, and/or the supervisor of the user 110, may log into the user profile of the user 110, to configure the user profile of the user 110. Such a configuration of the user profile may include one or more of addition and/or deletion of one or more user activities to be performed by the user 110, the set of threshold values for each of the one or more user activities, addition and/or deletion of one or more tracking devices to receive the progress status, addition and/or deletion of one or more user devices for which a set of access rights is required, definition of a set of access rights for each of the one or more user devices, set one or more parameters of the first conversion algorithm, set one or more parameters of the second conversion algorithm, and/or the like. In an embodiment, the processor 302 may be operable to perform functionalities similar to that of the processor 202, of the tracking device 102, as explained in FIG. 2.

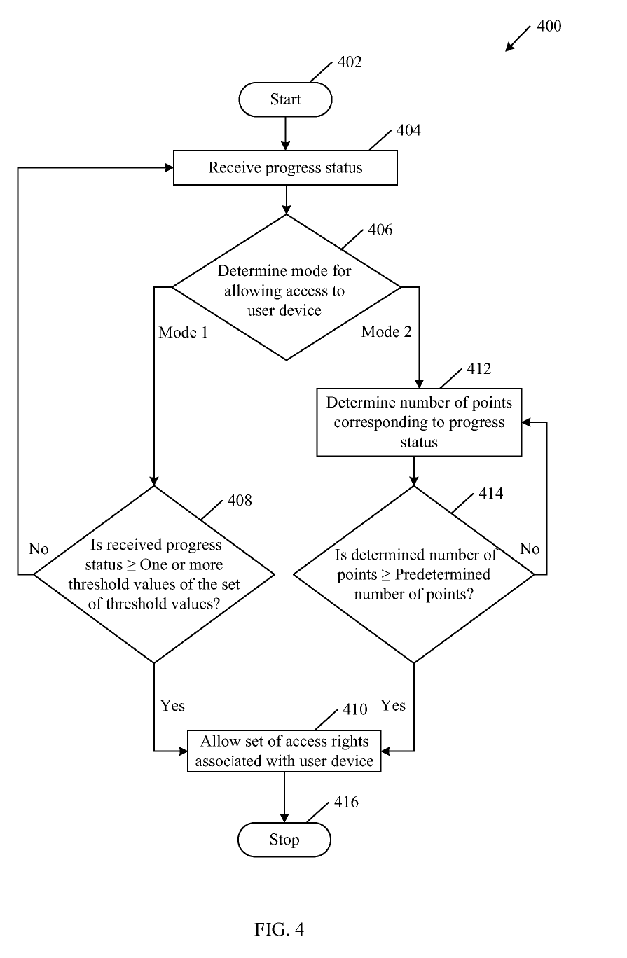

FIG. 4 is a flowchart illustrating a method for allowing access to electronic devices, in accordance with an embodiment of the disclosure. FIG. 4 is described in conjunction with elements of FIG. 1, FIG. 2, and FIG. 3. The method 400 may be implemented in the online application server 104, communicatively coupled to the tracking device 102, and/or the user device 106.

The method 400 begins at step 402, and proceeds to step 404. At step 404, a progress status associated with a user activity performed by the user 110, may be received by the online application server 104. The progress status may be received from the tracking device 102. At step 406, a mode for allowing access to the user device 106 may be determined by the online application server 104. In instances where the determined mode is a first mode, such as “Mode 1”, the control passes to step 408. At step 408, the received progress status of the user activity may be compared with a set of threshold values associated with the user activity. In instances where the received progress status does not exceed one or more threshold values of the set of threshold values, the control passes back to step 404. In instances where the received progress status equals or exceeds one or more threshold values of the set of threshold values, the control passes to step 410.

In instances where the determined mode is a second mode, such as “Mode 2”, the control passes to step 412. At step 412, a number of points that correspond to the received progress status may be determined by the online application server 104. At step 414, the determined number of points that correspond to the received progress status may be compared with a predetermined number of points. In instances where the determined number of points does not exceed the predetermined number of points, the control passes back to step 412. In instances where the determined number of points equals or exceeds the predetermined number of points, the control passes to step 410. At step 410, a set of access rights associated with the user device 106 may be allowed to the user 110. Control then passes to end step 416.

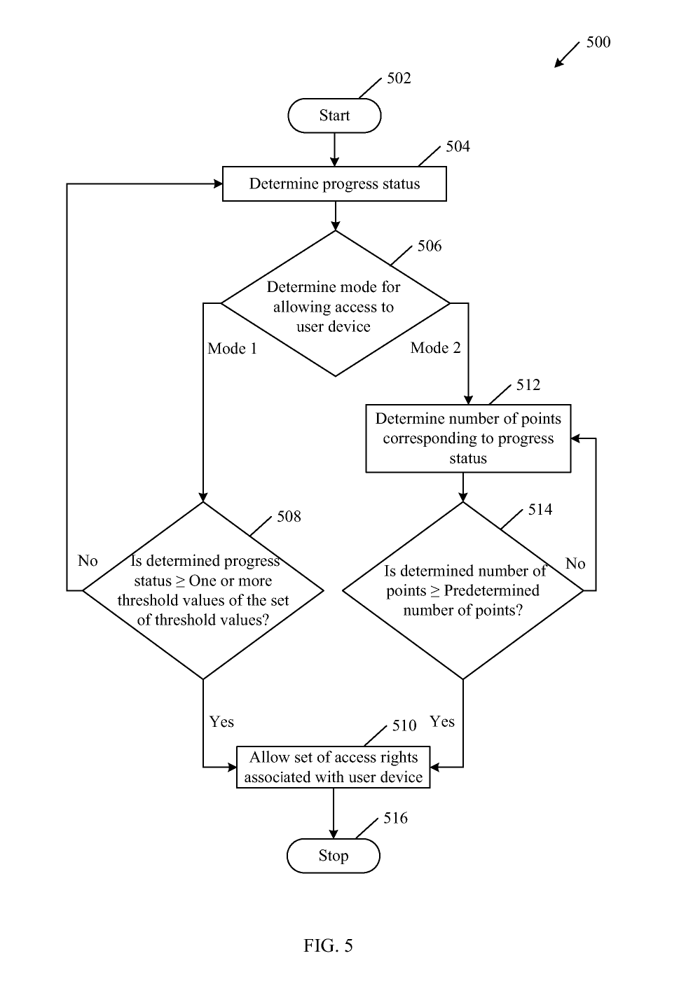

FIG. 5 is a flowchart illustrating a method for allowing access to electronic devices, in accordance with an embodiment of the disclosure. FIG. 5 is described in conjunction with elements of FIG. 1, FIG. 2, and FIG. 3. The method 500 may be implemented in the tracking device 102, communicatively coupled to the online application server 104, and/or the user device 106.

The method 500 begins at step 502, and proceeds to step 504. At step 504, a progress status associated with a user activity performed by the user 110 may be determined by the tracking device 102. At step 506, a mode for allowing access to the user device 106 may be determined by the tracking device 102. In instances where the determined mode is a first mode, such as “Mode 1”, the control passes to step 508. At step 508, the determined progress status of the user activity may be compared with a set of threshold values associated with the user activity. In instances where the determined progress status does not exceed one or more threshold values of the set of threshold values, the control passes back to step 504. In instances where the determined progress status equals or exceeds one or more threshold values of the set of threshold values, the control passes to step 510.

In instances where the determined mode is a second mode, such as “Mode 2”, the control passes to step 512. At step 512, a number of points that correspond to the determined progress status may be determined by the tracking device 102. At step 514, the determined number of points that correspond to the determined progress status may be compared with a predetermined number of points. In instances where the determined number of points does not exceed the predetermined number of points, the control passes back to step 512. In instances where the determined number of points equals or exceeds the predetermined number of points, the control passes to step 510. At step 510, a set of access rights associated with the user device 106 may be allowed to the user 110. Control then passes to end step 516.

In accordance with another embodiment of the disclosure, the tracking device 102 (FIG. 2) for allowing a set of access rights associated with the user device 106 (FIG. 1) is presented. Exemplary aspects of the disclosure may comprise one or more processors, such as the processor 202 (FIG. 2), in the tracking device 102. The processor 202 may be operable to monitor progress of a user activity performed by the user 110 (FIG. 1). The processor 202 may be operable to determine a progress status of the user activity based on the monitoring. The processor 202 may further be operable to allow access to the user device 106. The processor 202 may be operable to allow the access to the user device 106, based on the determined progress status.

In accordance with another embodiment of the disclosure, the online application server 104 (FIG. 3) for allowing a set of access rights associated with the user device 106 (FIG. 1) is presented. Exemplary aspects of the disclosure may comprise one or more processors, such as the processor 302 (FIG. 3), in the online application server 104. The processor 302 may be operable to receive a progress status that corresponds to a user activity performed by the user 110 (FIG. 1). The progress status may be received from the tracking device 102 (FIG. 2). The processor 302 may be further operable to allow access to the user device 106, based on the received progress status.

Various embodiments of the disclosure may provide a non-transitory computer readable medium and/or storage medium, and/or a non-transitory machine readable medium and/or storage medium having stored thereon, a machine code and/or a computer program having at least one code section executable by a machine and/or a computer for allowing access to a user device. The at least one code section in an online application server may cause the machine and/or computer to perform the steps comprising receiving a progress status from a first electronic device. The steps further comprise allowing access to a second electronic device, based on the received progress status.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a pre-defined area of an integrated circuit that also performs other functions.

The present disclosure may also be embedded in a computer program product, which comprises all the features enabling the implementation of the methods described herein, and which when loaded in a computer system is able to carry out these methods. Computer program, in the present context, means any expression, in any language, code or notation, of a set of instructions intended to cause a system having an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method comprising:
in an online application server communicably coupled to a first electronic device and a second electronic device:
receiving a progress status from said first electronic device, wherein said received progress status corresponds to a user activity performed by a user of said first electronic device; and
allowing access to said second electronic device based on said received progress status.

2. The method according to claim 1, further comprising comparing said received progress status with a set of threshold values associated with said user activity.

3. The method according to claim 2, wherein said access to said second electronic device is allowed based on said comparison.

4. The method according to claim 1, wherein said user activity comprises one or more of: performing exercises, playing outdoor games, performing work assignments, scoring grades in exams, reading books, performing chores, and/or participating in daily routine activities.

5. The method according to claim 1, wherein said first electronic device comprises one or more of: a smartphone, a touch screen device, a laptop, a tablet computer, a smartwatch, an imaging device, a personal digital assistant device, and/or fitness equipment.

6. The method according to claim 1, wherein said second electronic device comprises one or more of: a laptop, a television, a tablet computer, a desktop computer, a mobile phone, a video game console, a digital camera, and/or an audio/video player.

7. The method according to claim 1, further comprising determining a number of points based on said received progress status.

8. The method according to claim 7, wherein said determined number of points is stored in a database corresponding to a user profile associated with said user.

9. The method according to claim 7, further comprising determining a time period for allowing said access of said second electronic device based on said determined number of points.

10. The method according to claim 7, further comprising determining one or more applications and/or features associated with said second electronic device based on said determined number of points crossing a threshold level.

11. The method according to claim 7, wherein said one or more applications and/or features associated with said second electronic device comprise one or more of: games, multimedia, broadcast channels, social networking sites, messaging, calling and/or multimedia content associated with said second electronic device.

12. The method according to claim 1, wherein said allowing of said access of said second electronic device comprises one or more of: unlocking said second electronic device, unlocking one or more features associated with said second electronic device, and/or applications associated with said second electronic device.

13. A method comprising:
in a first electronic device communicably coupled to a second electronic device:
monitoring progress of a user activity performed by a user of said first electronic device;
determining a progress status of the user activity based on said monitoring; and
allowing access to said second electronic device based on said determined progress status.

14. The method according to claim 13, further comprising determining a number of points based on said determined progress status.

15. The method according to claim 14, wherein said determined number of points is stored in a database corresponding to a user profile associated with said user.

16. The method according to claim 14, further comprising determining a time period for allowing said access of said second electronic device based on said determined number of points.

17. The method according to claim 14, further comprising determining one or more applications and/or features associated with said second electronic device based on said determined number of points crossing a threshold level.

18. A method for allowing a set of access rights associated with one or more electronic devices, said method comprising:
in an online application server communicably coupled to said one or more electronic devices:
receiving a progress status from said one or more electronic devices, wherein said received progress status corresponds to each of one or more user activities performed by a user of said one or more electronic devices; and
allowing said set of access rights associated with said one or more electronic devices based on said received progress status.

19. The method according to claim 18, further comprising comparing said received progress status with a set of threshold values associated with each of said one or more user activities.

20. A system comprising:
one or more processors in a first electronic device communicably coupled to a second electronic device, said one or more processors being operable to:
monitor progress of a user activity performed by a user of said first electronic device;
determine a progress status of the user activity based on said monitoring; and
allow access to said second electronic device based on said determined progress status.

21. A system comprising:
one or more processors in an online application server communicably coupled to a first electronic device and a second electronic device, said one or more processors being operable to:
receive a progress status from said first electronic device, wherein said received progress status corresponds to a user activity performed by a user of said first electronic device; and
allow access to said second electronic device based on said received progress status.
